(19) United States
(12) Patent Application Publication
(10) Pub. No.: US 2010/0268942 A1
(43) Pub. Date: Oct. 21, 2010

(54) Systems and Methods for Using Cryptographic Keys

(75) Inventors: Jorge López Hernández-Ardieta, Madrid (ES); Fernando Hernández Álvarez, Madrid (ES); Carlos Jiménez Suárez, Madrid (ES)

Correspondence Address: Stevens Law Group, 1754 Technology Drive, Suite #226, San Jose, CA, 95110, US

(73) Assignee: Secuware, Madrid (ES)

(21) Appl. No.: 12/424,324

(22) Filed: Apr. 15, 2009

(51) Int. Cl. H04L 9/00

(52) U.S. Cl. 713/156

(57) ABSTRACT

Systems and methods for using cryptographic keys read an existing digital certificate from a hardware cryptographic device and extract a public key from the existing digital certificate. A certificate request message is generated that identifies a new usage and/or certificate field associated with the public key. The certificate request message is signed and communicated to a certification authority. A new digital certificate is received from the certification authority that includes the new usage/field. The new digital certificate is then applied to cryptographic operations, such as signing procedures, encryption procedures and so forth using the existing key pair.

### BACKGROUND

The invention relates generally to systems and methods for using (and reusing) cryptographic keys for various purposes. In particular, the described systems and methods allow a user to reuse a pair of cryptographic keys for purposes that are different from the purposes under which the keys were initially issued, or associating different/additional information (e.g., fields of a certificate) with the digital identity of the key pair's owner.

Certain cryptographic systems use two keys, referred to as a public key and a private key. The public key is known publicly and the private key is known only to a particular user. A message or other data is encrypted using the public key and later decrypted by the recipient using their private key. The public and private keys are related in a manner that permits the public key to encrypt a message such that only the related private key can decrypt the message. Anyone who knows the public key of a particular user can send an encrypted message to that user with substantial certainty that only the intended recipient will be able to access the message content. This type of encryption is popular when communicating messages and other data across public networks, such as the Internet. The cryptographic operation can be reversed, in the sense that the private key can be used at first to encrypt a hash of the message and the public key afterwards to decrypt it. Certain digital signature schemes use this mode of operation. Thus, the authentication of the origin of the data and the data integrity are assured, as the origin is the only one who knows the private key and any modification of the signed message is detected.

A public key infrastructure (PKI) was developed to allow the use of public key cryptography (PKC) in open and insecure environments, and with an unlimited number of potential users. In PKI, the public key is bound to an identity via a digital certificate. When an entity or another user successfully verifies a digital signature by using the public key embedded in a digital certificate, the identity of the signatory is the one contained in the digital certificate. The issuer of the digital certificate is referred to as the Certification Authority (CA). In certain situations, there are several levels of CAs. The CA on the first level is referred to as the root CA. Each CA issues the digital certificates of the subordinated CAs. End user digital certificates are issued by CAs that belong to the last level of the hierarchy.

Each digital certificate is digitally signed by the corresponding issuer to assure the authenticity of the information contained in the digital certificate. A digital certificate is valid if its integrity is maintained (e.g., the signature of the CA is verified correctly). The validity of a digital certificate may also depend on a validity period included within the digital certificate. The status of a digital certificate is valid if the digital certificate has not been revoked or suspended by the subscriber or another authorized entity. For example, the digital certificate is revoked if the corresponding private key is compromised or the subscriber suspects that is has been compromised. A digital certificate is also revoked or suspended if the purposes for which the digital certificate was issued are no longer in effect. For example, if a digital certificate is issued to an employee to access an enterprise network, the digital certificate is revoked upon termination of the employee.

When a digital certificate is revoked, its unique serial number is stored along with the revocation time and reason for the revocation by the CA. This information is typically stored in a certificate revocation list (CRL). When a digital certificate is revoked, the corresponding private key is no longer useful, thereby preventing improper or malicious use of the private key. The relationship between the subscriber and the CA is formalized through use of a certification practice statement (CPS). The CPS establishes the mechanisms and procedures followed by the CA to issue and manage digital certificates as well as the obligations, responsibilities and rights of the subscriber requesting a digital certificate. The CPS also describes the registration process in which the user is authenticated by a registration authority (RA) before issuing the digital certificate. During this authentication process, the user provides information needed to create the digital certificate. This information is authenticated by the RA using one or more techniques.

Existing systems often issue digital certificates for a particular set of usages (or purposes), thereby restricting the use of the digital certificate in the future as new usages are created or the user desires support for additional usage types. If the user needs a certificate for a purpose that is not allowed by the current digital certificate, they must request a new digital certificate and repeat the registration and issuance process. When using hardware devices to store the key pairs, a new hardware device is required to store the new key pair, thereby requiring the user to maintain multiple hardware devices. If the user applies the same PIN (Personal Identification Number) to each of the multiple hardware devices, the overall security level may be diminished.

### BRIEF DESCRIPTION OF THE DRAWINGS

FIG. 1 depicts an example public key infrastructure (PKI) environment in which the systems and methods discussed herein can be applied.

FIG. 2 depicts an example system capable of implementing the procedures discussed herein.

FIG. 3 depicts a flow diagram of an example procedure for issuing a digital certificate.

FIG. 4 depicts a flow diagram of an example procedure for issuing a new digital certificate.

FIG. 5 depicts an example exchange between an end user and a certification authority (CA) for issuing a new digital certificate.

Throughout the description, similar reference numbers may be used to identify similar elements.

### DETAILED DESCRIPTION

The systems and methods described herein reuse cryptographic keys embedded in a hardware cryptographic device (HCD), such as a smart card or USB token. These systems and methods expand the usefulness of the private key while maintaining the existing security requirements. As discussed herein, certain embodiments re-issue the public key to permit additional usages of the key or to add new fields that enable use of the public-private key pair in new applications. For example, the user may operate the HCD in a normal manner, but the public key maintained in the HCD is extracted and a new digital certificate with the new key usages (or new fields) is requested from the appropriate certification authority (CA). Thus, the user does not need to replace their existing HCD to use their existing public-private key pair for new purposes. The re-issuance of the cryptographic keys is transparent to the user. In particular, the user does not need to request a new key pair with new usages or fields, which would require the user to manage multiple HCDs. Instead, the existing key pair is extended with the new usages or fields while the HCD is unchanged.

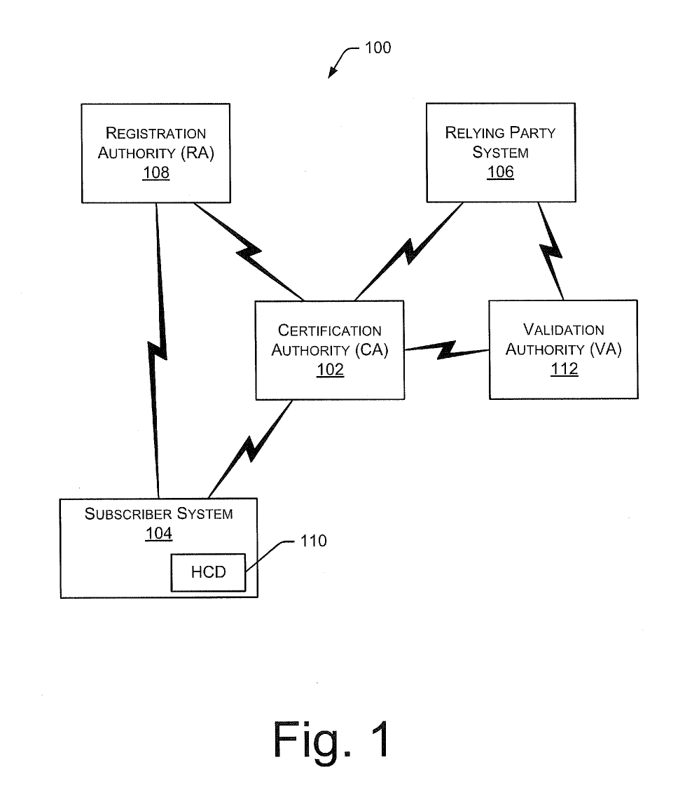

FIG. 1 depicts an example public key infrastructure (PKI) environment 100 in which the systems and methods discussed herein can be applied. Environment 100 supports digital certificate issuance as well as digital certificate validation. A certification authority (CA) 102 is coupled to a subscriber system 104, a relying party system 106, a registration authority (RA) 108, and a validation authority (VA) 112. Subscriber system 104 is a computer or other device capable of performing the subscriber-based tasks discussed herein. Subscriber system 104 includes a HCD 110 that stores the public-private key pair associated with the subscriber. HCD 110 is any type of hardware device capable of storing public-private key pairs as discussed herein. Example HCDs include smart cards, USB (Universal Serial Bus) tokens, and the like. HCD 110 may also store other data used by the subscriber. Relying party system 106 is a computer or other device capable of performing the relying party-based tasks discussed herein.

A subscriber requests a digital certificate by presenting credentials to registration authority 108 to prove the subscriber's identity. This identification process can be performed remotely using online methods or physically, such as an in-person appearance and presentation of photo-based credentials by the subscriber. In the embodiment of FIG. 1, registration authority 108 communicates validated subscriber information to certification authority 102. In one embodiment, the activities of registration authority 108 and certification authority 102 are performed by the same entity. In other embodiments, these activities are performed by two or more different entities.

Proper generation of the public-private key pair is important to ensure a high level of security within environment 100. Key pairs may be generated using a software application installed on subscriber system 104. In another implementation, the certification authority 102 can generate key pairs using software and/or hardware components, which typically provides a higher level of security in the key pair generation process. The subscriber registration process in registration authority 108 is also important to the security within environment 100.

After the subscriber has been properly identified and authenticated, certification authority 102 generates a digital certificate for that subscriber. The digital certificate includes information provided by registration authority 108, the public key and other parameters that depend on the certificate profile and the certification practice statement (CPS). Certification authority 102 then provides the digital certificate to the subscriber. If the key pair is generated by certification authority 102, then the subscriber also obtains the private key from certification authority 102 via the Internet or physically at the certification authority location. In a particular embodiment, the digital certificate and the private key are embedded in HCD 110 by certification authority 102, which is then provided to the subscriber for use in subscriber system 104. In alternate embodiments, the digital certificate and the private key are stored in a software application. If the private key is issued for non-repudiation purposes, the certification authority 102 does not store a copy of the private key after distribution to the subscriber.

A digital certificate is a collection of information relating to the subscriber's identity, the public key associated with that identity, and the issuer identity. The digital certificate also includes a serial number that uniquely identifies the digital certificate within the public key infrastructure. Digital certificates also include information regarding the validity period of the digital certificate and the purposes/applications for which the subscriber can use the private key associated with the public key that is contained in the digital certificate. Thus, a particular digital certificate is issued for a specific subset of purposes, but not generally for all purposes. Example purposes include digital signatures, encryption of data, key agreement, and certificate signing (commonly referred to as “cryptographic operations”).

When validating received messages or other data, the relying party uses the certificate revocation list (CRL) to ensure that the digital certificate has not been revoked. Relying party system 106 may perform the validation of the received message itself or may request validation of the received message by a validation authority (VA) 112. Validation authority 112 also uses the CRL received from certification authority 102 to validate the digital certificates received from the relying party.

The validation process performed by the relying party or a validation authority validates the digital certificate (e.g., to ensure that it has not been revoked). The digital certificate is invalid if, for example, it has been revoked. The relying party or a validation authority may also validate cryptographic data (e.g., digital signature, encrypted message, etc.) by using the signer's digital certificate. In this case, the relying party or the validation authority also validates the purpose for which the digital certificate is being used. The certificate is invalid if it is being used for an unintended purpose.

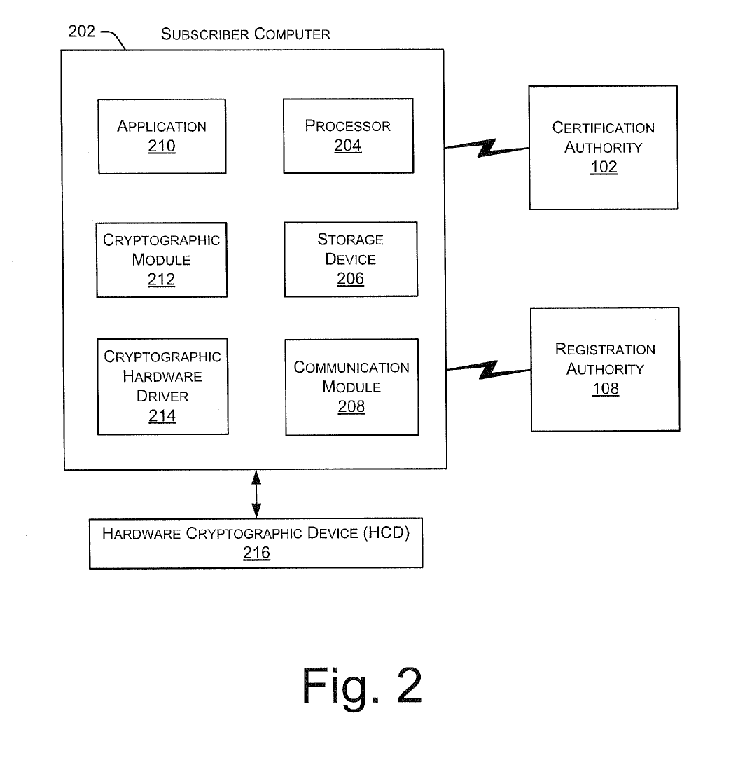

As mentioned above, the systems and methods described herein permit the reuse of the same public-private key pair for purposes (or with fields) that are different than when the key pair was originally created. FIG. 2 depicts an example system capable of implementing the procedures discussed herein. A subscriber computer 202 is capable of communicating with certification authority 102 and registration authority 108. Subscriber computer 202 can be any type of computing device capable of performing the operations discussed herein. For example, subscriber computer 202 may be a desktop computer, a laptop computer, handheld computer, smart phone, game console, set top box, and the like.

Subscriber computer 202 is coupled to a hardware cryptographic device (HCD) 216 via a universal serial bus (USB) or other communication link. As mentioned herein, particular embodiments of HCD 216 include a smart card or a USB token. In other embodiments, HCD 216 can be any type of device capable of storing data and interacting with subscriber computer 202 as discussed herein. Particular embodiments of HCD 216 include an EEPROM (Electrically Erasable Programmable Read-Only Memory) to store data. HCD 216 typically has limited storage space and may not permit storage of new data within the HCD after the initial public-private key pair and related data are stored within the HCD. Other embodiments of HCD 216 permit storage of new digital certificates and corresponding keys if space is available within the HCD. In a particular embodiment, HCD 216 is inserted into a card reader or other device coupled to subscriber computer 202.

Subscriber computer 202 includes a processor 204, a storage device 206, and a communication module 208. Processor 204 performs various operations necessary during the operation of subscriber computer 202. For example, processor 204 performs several procedures and methods discussed herein to create, manage, and process various cryptographic data and related information.

Storage device 206 stores data and other information used during the operation of subscriber computer 202. Storage device 206 may include one or more volatile and/or non-volatile memories. In a particular embodiment, storage device 206 includes a hard disk drive as well as volatile and non-volatile memories. Communication module 208 communicates data between subscriber computer 202 and other devices, such as certification authority 102 and registration authority 108.

Subscriber computer 202 also includes an application 210, a cryptographic module 212, and a cryptographic hardware driver 214. These three components (210, 212, and 214) of subscriber computer 202 may be referred to as different “layers” of the system. Application 210 is a software application that makes use of the cryptographic systems and methods discussed herein when communicating data or performing other tasks that use cryptographic keys. Examples of application 210 include web-based applications, email frameworks, signature creation applications, and the like. Cryptographic module 212 operates on a lower layer (e.g., below application 210) and communicates with HCD 216 through cryptographic hardware driver 214. In certain embodiments, cryptographic module 212 manages communication of data to and from certification authority 102. Cryptographic hardware driver 214 communicates directly with HCD 216, for example, to retrieve public key and other accessible information stored in HCD 216.

The systems and methods discussed herein allow a public key to be reissued for additional purposes and/or for additional/different certificate fields. Subscriber computer 202 supports the reissuance of public keys as described herein. In a particular embodiment, HCD 216 stores a private key in a secure manner and allows access to the digital certificate that “wraps” the corresponding public key. Access to and retrieval of the digital certificate can be optionally protected using a PIN or password. Access to the private key is protected through use of a PIN or password. Usage of the public key is defined by various digital certificate extensions, some of which are discussed herein. In certain embodiments, the public key usage includes all standardized key usages (e.g., all purposes).

During normal usage of HCD 216, the user may need to perform a cryptographic operation that is not supported by the current usages/fields associated with the public key stored on the HCD. For example, an email application may require a digital certificate that includes an email field. If the existing digital certificate stored on HCD 216 does not include an email field, a new digital certificate is needed to allow the email application to perform its designated function.

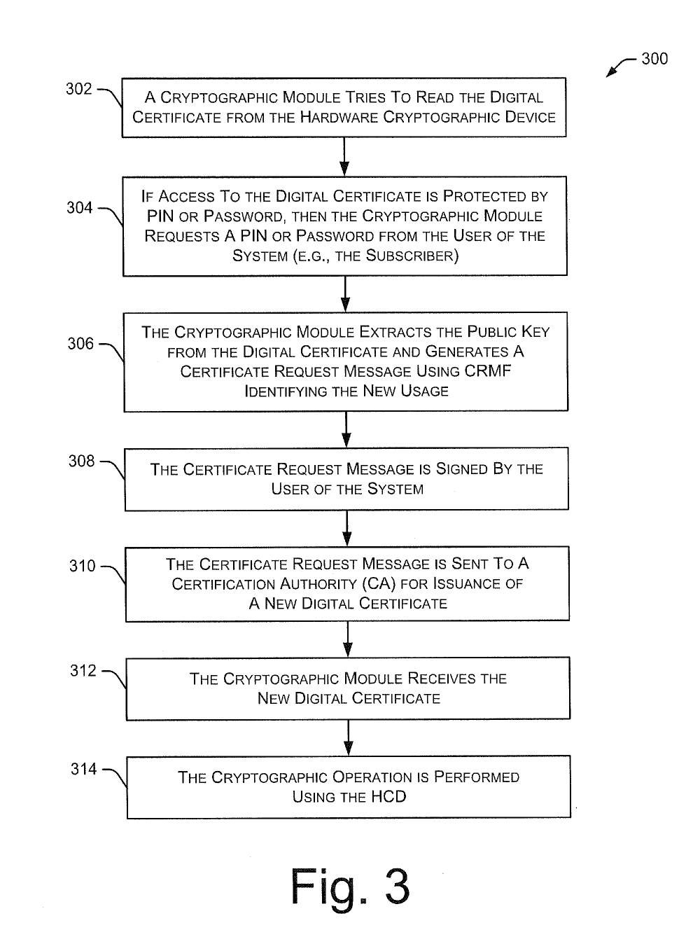

FIG. 3 depicts a flow diagram of an example procedure 300 for issuing a digital certificate. Initially, a cryptographic module (e.g., cryptographic module 212 in FIG. 2) tries to read the digital certificate from a hardware cryptographic device (e.g., HCD 216) at block 302. If the access to the digital certificate is protected by PIN/password, then the cryptographic module requests the PIN or password from the user of the system, such as the subscriber (block 304). This step is optional—certain systems may not require a PIN or password for accessing the digital certificate.

Next, the cryptographic module extracts the public key from the digital certificate and generates a certificate request message using CRMF (Certificate Request Message Format) and identifying the new usage desired (block 306). The certificate request message is signed by the user of the system (block 308) by having the user enter the appropriate PIN or password. The certificate request message is then sent to a certification authority (e.g., certification authority 102) for issuance of a new digital certificate (block 310). The certification authority is selected based on the specific application context, such as an email application desiring a digital certificate that includes an email field, as discussed above. The selected certification authority should be able to process CRMF requests and issue digital certificates with the new key usage requested in the certificate request message. In a particular embodiment, a “proof of possession” is included in the certificate request message using in-band messages that are transparent to the user. The “proof of possession” used may vary depending on the policies of the certification authority and/or registration authority.

After processing by the certification authority, the cryptographic module receives the new digital certificate (block 312). The cryptographic operation is then performed by the subscriber computer using the new digital certificate and the hardware cryptographic device (block 314). The user is required to enter the PIN or password in order to perform the cryptographic operation. The new digital certificate is not necessarily stored on the hardware cryptographic device. In one embodiment, the new digital certificate is used once and discarded. If a similar digital certificate is needed in the future, procedure 300 is repeated to obtain a new digital certificate. In another embodiment, the new digital certificate is stored within the hardware cryptographic device or stored in subscriber computer 202 (e.g., in storage device 206) for future use.

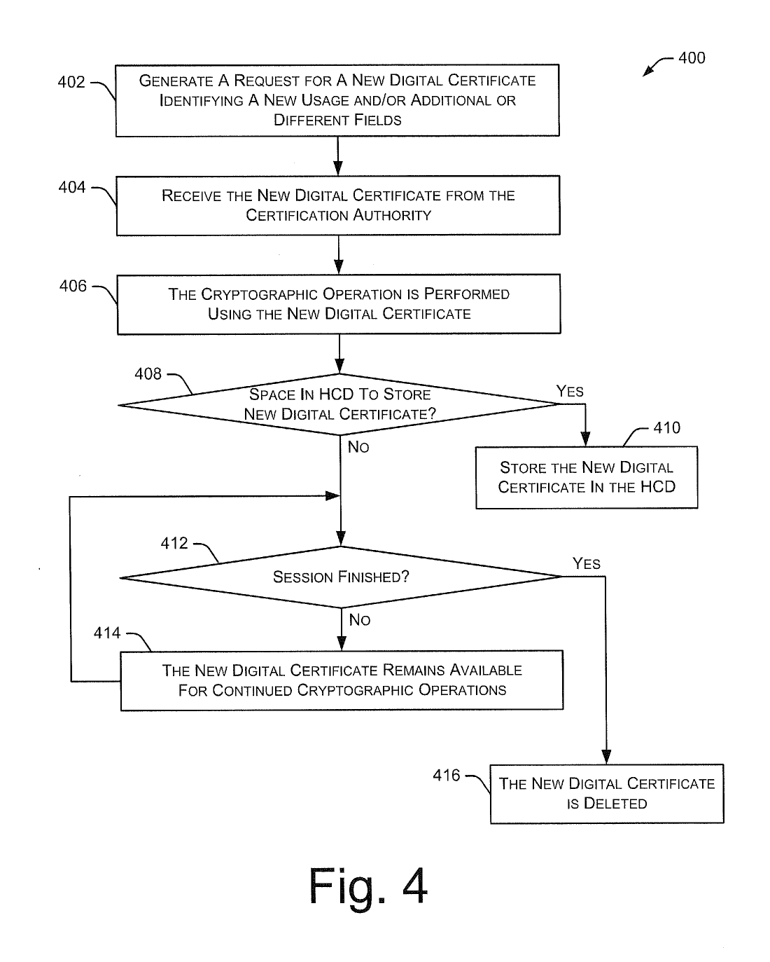

FIG. 4 depicts a flow diagram of an example procedure 400 for issuing a new digital certificate. The new digital certificate is issued for use during one or more sessions. In certain implementations, the new digital certificate is deleted at the end of each session—if another digital certificate is needed in a future session, a different digital certificate is issued for use during that future session.

Initially, procedure 400 generates a request for a new digital certificate identifying a new usage and/or additional or different fields (block 402). The new digital certificate is received from the certification authority (block 404) and the cryptographic operation is performed using the new digital certificate (block 406). The procedure continues by determining whether the HCD has space to store the new digital certificate (block 408). If there is available space in the HCD, the procedure stores the new digital certificate in the HCD (block 410).

If the HCD does not have space to store the new digital certificate, then the procedure continues by determining whether the current session has finished (block 412). In one embodiment, a session remains active while the hardware cryptographic device is connected to the subscriber's computer. If the session has not finished (i.e., the session is still active), the new digital certificate remains available for continued cryptographic operations (block 414). When the session is finished, the new digital certificate is deleted (block 416). If another session is activated in the future requiring a similar digital certificate for an additional use, the procedure of FIG. 4 is repeated. Procedure 400 allows a subscriber to add new usages/fields to a key pair stored in an existing hardware cryptographic device rather than replacing it with a new device that stores a new key pair supporting the new usages/fields.

In an alternate embodiment, the procedure of FIG. 4 is modified to generate a one-time digital certificate. A one-time digital certificate is issued for use during one particular session, but deleted at the end of that session. If another digital certificate is needed in a future session, a different one-time digital certificate is issued for use during that future session. The one-time digital certificate is stored, for example, in the RAM (Random Access Memory) or similar volatile storage device in the subscriber's computer. In a particular embodiment, a session remains active while the hardware cryptographic device is connected to the subscriber's computer. A session ends when the hardware cryptographic device is disconnected, causing deletion of the one-time digital certificate from the subscriber computer's RAM or other storage device. This alternate procedure is similar to the procedure of FIG. 4, with the removal of blocks 408 and 410. Thus, the new digital certificate is used during the current session, and is not stored in the HCD, regardless of whether the HCD has space available to store the new digital certificate. The new digital certificate is deleted at the end of a session even if the HCD is capable of storing the new digital certificate.

An example implementation of the systems and methods discussed herein provides for the protection of email messages. In this implementation, email messages are protected using cryptographic techniques applied via software and/or hardware. When using the methods and systems described herein, email messages can be protected without requiring any additional tools or requiring a new hardware cryptographic device containing a new digital certificate that supports protection of email messages. A modified digital certificate including the specific key usage is requested and processed as discussed herein.

In another example implementation, the user sends secure email messages where the user's identity is assured by cryptographic data, such as a digital signature. In this example, the user only receives email messages in which the email sender identity is authenticated by means of the digital certificate (e.g., the email field of the digital certificate includes the sender's email address). This implementation eliminates or significantly reduces the amount of SPAM (unsolicited bulk email) received by the user.

In a particular embodiment, communication between subscriber computer 202 and certification authority 102 uses the following procedure. Initially, subscriber computer 202 extracts the public key contained in the digital certificate embedded in HCD 216. Once the public key is extracted from the HCD, the subscriber computer generates a new certificate request message (in CRMF). This message is requests a new key usage (KeyUsage) and/or new information fields (e.g., an EMAIL field). The new certificate request message is protected with several methods which verify the Proof-of-Possession (PoP) of the private key.

Next, the new certificate request message is sent to the certification authority for its processing. After the certification authority has verified the message, including the PoP, a new digital certificate containing the information detailed in the certificate request message is issued to the end user via the subscriber computer. The subscriber computer generates a protected confirmation message to finalize the procedure. Before sending the protected confirmation message, the subscriber computer verifies the accuracy of the new digital certificate. This verification determines the integrity of the new digital certificate and the validity period. If a validation authority is available through an Online Certificate Status Protocol (OCSP) service, then the revocation state of the certificate can be validated as well.

In a particular implementation of the public key extraction process, before extracting the public key, the subscriber computer reads one or more digital certificates already stored in the HCD to determine whether the action required by the user is supported by one of those digital certificates. If the key usage needed to carry out this action is already supported by one of the existing digital certificates, the process ends. Otherwise, a new digital certificate with a new key usage and/or new field is requested.

The public key stored in the HCD extracted by the subscriber computer can be stored in a public access zone or in a private access zone. Depending on the current storage method for the public key, the extraction process differs. If the public key is stored in a public access zone, the subscriber computer extracts it directly and continues with generation of the certificate request message requesting a new key usage or field. If the public key is stored in a private access zone, the user will be asked to insert their PIN or password to obtain a digital certificate that permits extraction of the public key.

Each time a new digital certificate is issued, its accuracy and validity is verified by the subscriber (e.g., via the subscriber computer). Thus, the public key extracted from the HCD can be stored in memory with no protection mechanism. If the public key is modified by an attacker before the certificate request message is created, the subscriber computer will detect this modification before confirming the process.

In a particular embodiment, a protocol referred to as CMC (Certificate Management over CMS (Cryptographic Message Syntax (CMS)) is used when implementing the systems and methods described herein. The Cryptographic Message Syntax (CMS) describes an encapsulation syntax for data protection and is used to digitally sign, digest, authenticate, or encrypt arbitrary message content. In this embodiment, every message sent between an end user and a certification authority will be signed with the corresponding entity's private key to assure the integrity and authenticity of the exchange.

CMC defines two different types of requests and of responses: a “full” and a “simple” PKI request/response. In a particular embodiment, cryptographic module 212 described herein uses the full PKI request. The full PKI request, whose main body is PKI Data, is encapsulated in either a SignedData field or an AuthenticationData field to assure its integrity and/or authentication.

In a particular implementation, the PKI Data ASN.1 structure is:

PKIData ::= SEQUENCE {
controlSequence SEQUENCE SIZE(0..MAX) OF TaggedAttribute,
reqSequence SEQUENCE SIZE(0..MAX) OF TaggedRequest,
cmsSequence SEQUENCE SIZE(0..MAX) OF TaggedContentInfo,
otherMsgSequence SEQUENCE SIZE(0..MAX) OF OtherMsg
}

Where controlSequence is a sequence of controls that define the actions the PKI Request needs to perform. reqSequence is a sequence of certificate request messages. cmsSequence is a sequence of CMS message objects. otherMsgSequence is a sequence of arbitrary data objects. These data objects are referred to one or more controls.
As mentioned above, there are two types of PKI Responses, simple and full. The election of the type depends on the success or failure of the request and it is made by the certification authority. If the request is successful, the certification authority will use a simple PKI Response. However, if any failure occurs, the certification authority will use either a full PKI Response or it will choose not to return anything. Therefore the cryptographic module will deal with both types depending on the certification authority.

A simple PKI Response consists of a SignedData with no EncapsualtedContentInfo and no SignerInfo. The certificates requested in the PKI Request are returned in the certificate field of SignedData. The certification authority includes all the certificates needed to form complete certification paths. This simple PKI Response can be used by the certification authority since no proof-of-identity needs to be included (the end user identity is proved indicating the digital certificate is already issued for the public key embedded in the request).
A full PKI Response consists of a SignedData or an AuthenticationData encapsulated in a PKIResponse structure. In this situation, the certificates issued in the response are returned in the certificates field of the immediately encapsulating SignedData.
The content type used in the full PKI Response is the PKI Response, whose ASN.1 structure is:

```
PKIResponse ::= SEQUENCE {
          controlSequence SEQUENCE SIZE(0..MAX) OF
          TaggedAttribute,
          cmsSequence SEQUENCE SIZE(0..MAX) OF
          TaggedContentInfo,
          otherMsgSequence SEQUENCE SIZE(0..MAX) OF OtherMsg
}
ReponseBody ::= PKIResponse
```

The fields of the PKI Response have the same meaning as in the PKI Data discussed herein.
Each element of PKI Data or PKI Response has an associated identifier, and all of them are encoded in the cerReqIds field of CertReqMsg objects (in the CRFM). This identifier is unique in the same PKI Data/Response. The bodyPartID value of 0 is reserved for using as the reference to the current PKI Data object.
   Extended CMC Status Info control will also use these identifiers to refer to elements in the previous PKI Data/Response. Using this approach, the system maintains control over any errors that occur.
The different fields of PKI Data and PKI Response discussed above are described in greater detail below.
   The TaggedAttribute structure is the following:

TaggedAttribute ::= SEQUENCE {
bodyPartID BodyPartID,
attrType OBJECT IDENTIFIER,
attrValues SET OF AttributeValue
}

Where bodyPartID is an integer that identifies the control, attrType is the Object Identifier that identifies the control, and attrValues represents the data values used in the corresponding control.
The following table lists the name, object identifier, and syntactic structure for the controls defined in the CMC protocol:

| Identifier Description | OID | ASN.1 Structure |
|---|---|---|
| id-cmc-statusInfo | id-cmc 1 | CMCStatusInfo |
| id-cmc-identification | id-cmc 2 | UTF8String |
| id-cmc-identityProof | id-cmc 3 | OCTET STRING |
| id-cmc-dataReturn | id-cmc 4 | OCTET STRING |
| id-cmc-transactionId | id-cmc 5 | INTEGER |
| id-cmc-senderNonce | id-cmc 6 | OCTET STRING |
| id-cmc-recipientNonce | id-cmc 7 | OCTET STRING |
| id-cmc-addExtensions | id-cmc 8 | AddExtensions |
| id-cmc-encryptedPOP | id-cmc 9 | EncryptedPOP |
| id-cmc-decryptedPOP | id-cmc 10 | DecryptedPOP |
| id-cmc-lraPOPWitness | id-cmc 11 | LraPOPWitness |
| id-cmc-getCert | id-cmc 15 | GetCert |
| id-cmc-getCRL | id-cmc 16 | GetCRL |
| id-cmc-revokeRequest | id-cmc 17 | RevokeRequest |
| id-cmc-regInfo | id-cmc 18 | OCTET STRING |
| id-cmc-responseInfo | id-cmc 19 | OCTET STRING |
| id-cmc-queryPending | id-cmc 21 | OCTET STRING |
| id-cmc-popLinkRandom | id-cmc 22 | OCTET STRING |
| id-cmc-popLinkWitness | id-cmc 23 | OCTET STRING |
| id-cmc-popLinkWitnessV2 | id-cmc 33 | OCTET STRING |
| id-cmc-confirmCertAcceptance | id-cmc 24 | CMCCertId |
| id-cmc-statusInfoV2 | id-cmc 25 | CMCStatusInfoV2 |
| id-cmc-trustedAnchors | id-cmc 26 | PublishTrustAnchors |
| id-cmc-authData | id-cmc 27 | AuthPublish |
| id-cmc-batchRequests | id-cmc 28 | BodyPartList |
| id-cmc-batchResponses | id-cmc 29 | BodyPartList |
| id-cmc-publishCert | id-cmc 30 | CMCPublicationInfo |
| id-cmc-modCertTemplate | id-cmc 31 | ModCertTemplate |
| id-cmc-controlProcessed | id-cmc 32 | ControlsProcessed |
| id-cmc-identityProofV2 | id-cmc 34 | IdentityProofV2 |

In certain implementations, not all the controls will be necessary. For example, controls related to the identity proof are not used in certain embodiments since the cryptographic module is renewing an existing certificate. A renewal is similar to other certification requests except the identity proof is supplied by existing certificates from a trusted certification authority. Thus, by providing the necessary certificates to verify the public key the identity proof of the end user is performed. There is a field in the SignedData structure which manages this task.

Another example of controls that may not be necessary in certain implementations is the EncryptedPOP and DecryptedPOP, whose function is to provide the Proof-of-Possession of the end user key pair to the certification authority.
In particular embodiments, the controls used by the cryptographic module are discussed as follows. CMCStatusInfo returns information about the status of a client/server request/response. In particular, the Extended CMC Status Info control provides:

CMCStatusInfoV2 ::= SEQUENCE {
cMCStatus CMCStatus,
bodyList SEQUENCE SIZE (1..MAX) OF BodyPartReference,
statusString UTF8String OPTIONAL,
otherInfo OtherStatusInfo OPTIONAL
}

The cMCStatus field contains the status value. It has several options representing the success or failure of a specific operation:

| CMCStatus ::= INTEGER { | |
|---|---|
| success | (0), |
| -- reserved | (1), |
| failed | (2), |
| pending | (3), |
| noSupport | (4), |
| confirmRequired | (5), |
| popRequired | (6), |

partial (7)
}

The bodyList field identifies the controls to which the status value applies. If there is an error, this field is the bodyPartID choice of BodyPartReference with the value 1. The statusString field may be omitted in certain implementations, such as when the additional description information it gives is not necessary. The otherInfo field contains additional information expanding the one indicated on the CMC status code returned. Its structure is:

OtherStatusInfo ::= CHOICE {
failInfo CMCFailInfo,
pendInfo PendInfo,
extendedFailInfo ExtendedFailInfo
}

Where failInfo provides an error code detailing the failure occurred:

| CMCFailInfo ::= INTEGER { | |
|---|---|
| badAlg | (0), |
| badMessageCheck(1), | |
| badRequest (2), | |
| badTime (3), | |
| badCertId | (4), |
| unsupportedExt | (5), |
| mustArchiveKeys | (6), |
| badIdentity (7), | |
| popRequired (8), | |
| popFailed | (9), |
| noKeyReuse (10), | |
| internalCAError (11), | |
| tryLater | (12), |

authDataFail (13)
}

The pendInfo field is used when the cMCStatus was either pending or partial. It contains information about when and how the client should request the result of this request. extendedFailInfo is presented when the cMC Status was failed and it includes information about the detailed error.
TransactionID is a transaction Identifier control that identifies a given transaction. Each request and response belonging to the same transaction includes the same value for this control.

### TransactionId::=INTEGER

SenderNonce and RecipientNonce support replay protection. These controls work as follows: In the first message of a transaction the Sender Nonce is included by the end user. The recipient certification authority reflects this value back to the sender as a Recipient Nonce control and includes a new value as its Sender Nonce control. Then, the end user compares the value of the received Recipient Nonce with its own Sender Nonce and, if they match, the message is accepted.

SenderNonce ::= OCTET STRING
RecipientNonce ::= OCTET STRING

ConfirmCertAcceptance is a control that manages confirmation of the certificates issued by the certification authority and it enables the confirmation stage of the process.

Certification authorities require a positive confirmation that the certificates issued to the end user are acceptable. The CMCCertId structure contains the issuer and serial number of the certificate being accepted.

### CMCCertId::=IssuerAndSerialNumber

The confirmation stage is performed as follows: the certification authority selects as CMC Status Info on a PKI Response the option confirmRequired, then the client returns a Confirm Certificate Acceptance control in a Full PKI Request. Finally, the certification authority returns a PKI Response again with an Extended CMC Status Info of success.

Certification Request options. In this field the certification requests (CRMF) are included. The TaggedRequest structure is the following:

```
TaggedRequest ::= CHOICE {
tcr [0] TaggedCertificationRequest,
crm [1] CertReqMsg,
orm [2] SEQUENCE {
        bodyPartID BodyPartID,
        requestMessageType OBJECT IDENTIFIER,
        requestMessageValue ANY DEFINED BY requestMessageType
}
}
```

The different choices of this structure includes tcr which refers to the use of PKCS #10 syntax, crm refers to the use of CRMF syntax, and orm is an externally defined certification request. In particular embodiments, the cryptographic module uses the crm option when using Certification Request Message Format (CRMF).
The Cryptographic Message Syntax (CMS) support six different content types, but the CMC protocol considers four of them: AuthenticatedData, Data, EnvelopedData, and SignedData. Among these types the cryptographic module uses the SignedData type. The syntax for the CMS sequence structure is:

TaggedContentInfo ::= SEQUENCE {
bodyPartID BodyPartID,
contentInfo ContentInfo
}

bodyPartID is an integer that identifies this content info object and contentInfo is the corresponding ContentInfo object.
ContentInfo encapsulates a single identified content type which is able to provide further encapsulation (SignedData). The ContentInfo structure is:

ContentInfo ::= SEQUENCE {
contentType ContentType,
content [0] EXPLICIT ANY DEFINED BY contentType }
ContentType ::= OBJECT IDENTIFIER

SignedData is used to wrap the PKI Data to assure its security and is a substitute for the Proof-of-Possession for the corresponding public key. This PoP is done in each request, and is included in the CRMF structure. The signed-data content type consists of content of any type and zero or more signature values. The SignedData ASN.1 structure is:

SignedData ::= SEQUENCE {
version CMSVersion,
digestAlgorithms DigestAlgorithmIdentifiers,
encapContentInfo EncapsulatedContentInfo,
certificates [0] IMPLICIT CertificateSet OPTIONAL,
crls [1] IMPLICIT RevocationInfoChoices OPTIONAL,
signerInfos SignerInfos }
DigestAlgorithmIdentifiers ::= SET OF DigestAlgorithmIdentifier
SignerInfos ::= SET OF SignerInfo

The meaning of the SignedData fields includes version, which is the version number. Its calculation depends on certificates, eContentType, and SignerInfo fields. digestAlgorithm is the digest algorithm identifier and encapContentInfo is the signed content. It consists of a EncapsulatedContentInfo, whose structure is:

EncapsulatedContentInfo ::= SEQUENCE {
eContentType ContentType,
eContent [0] EXPLICIT OCTET STRING OPTIONAL }

where eContentType is an object identifier and eContent is the content itself. Embodiments of the cryptographic module will use this field when no external signature is used.
certificates is the collection of certificates needed to certify the path from a recognizing root certification authority to the signer in the signerInfos field. In particular embodiments, crls is omitted, and signerInfos is a collection of per-signer information stored in the SignerInfo structure:

SignerInfo ::= SEQUENCE {
version CMSVersion,
sid SignerIdentifier,
digestAlgorithm DigestAlgorithmIdentifier,
signedAttrs [0] IMPLICIT SignedAttributes OPTIONAL,
signatureAlgorithm SignatureAlgorithmIdentifier,
signature SignatureValue,
unsignedAttrs [1] IMPLICIT UnsignedAttributes OPTIONAL }
SignerIdentifier ::= CHOICE {
issuerAndSerialNumber IssuerAndSerialNumber,
subjectKeyIdentifier [0] SubjectKeyIdentifier }
SignedAttributes ::= SET SIZE (1..MAX) OF Attribute
UnsignedAttributes ::= SET SIZE (1..MAX) OF Attribute
Attribute ::= SEQUENCE {
attrType OBJECT IDENTIFIER,
attrValues SET OF AttributeValue }
AttributeValue ::= ANY
SignatureValue ::= OCTET STRING

The fields of SignerInfo have the following meaning: version is the syntax version number and it depends on the choice of SignerIdentifier. In a particular implementation, its value is 3 because the cryptographic module will use the subjectKeyIdentifier choice of the structure SignerIdentifier. sid specifies the signer's certificate and therefore the signer's public key, which is needed by the recipient to verify the signature. The SignerIdentifier provides two options to specify the public key, but the cryptographic module will typically use the subjectKeyIdentifier choice to identify the signer's certificate by means of a key identifier. digestAlgorithm identifies the message digest algorithm. This message digest is computed on the content together with the signed attributes.
signedAttrs is a collection of attributes and it is used, for example, when the EncapsulatedContentInfo is not id-data. This field contains at least two attributes: content-type has the content type of the EncapsulatedContentInfo and message-digest has the message digest of the content.
signatureAlgorithm identifies the signature algorithm, signature is the result of the digital signature generation using the message digest and the signer's private key, and unsignedAttrs are omitted.
The SignedData structure is used to provide authentication and integrity to the PKI Request by signing the PKI Data. As discussed herein, there are three specified high-level purposes for which a Proof-of-Possession is used: Signature, Key Encypherment and Key Agreement. Therefore, a certificate stored in the Hardware Cryptographic Device (HCD) will typically be of one of these three types. Thus, there are three options: If the key pair has the signature purpose associated, the signature which wraps the PKI Data can be generated directly. Otherwise, if the end user has any of the other two types of certificates, the signature cannot be generated directly. In this situation, another process is carried out to allow generating a signature using the private key material of an embedded signature certification request, i.e., included in the tcr or crm fields of the TaggedRequest.
Other messages. In this field, arbitrary data objects that are not defined in CMS are carried. Its structure and the meaning of the fields are:

OtherMsg ::= SEQUENCE {
bodyPartID BodyPartID,
otherMsgType OBJECT IDENTIFIER,
otherMsgValue ANY DEFINED BY otherMsgType }

where bodyPartID is the identifier for this object, otherMsgType is the Object Identifier of the type of the message body, and otherMsgValue is the data.

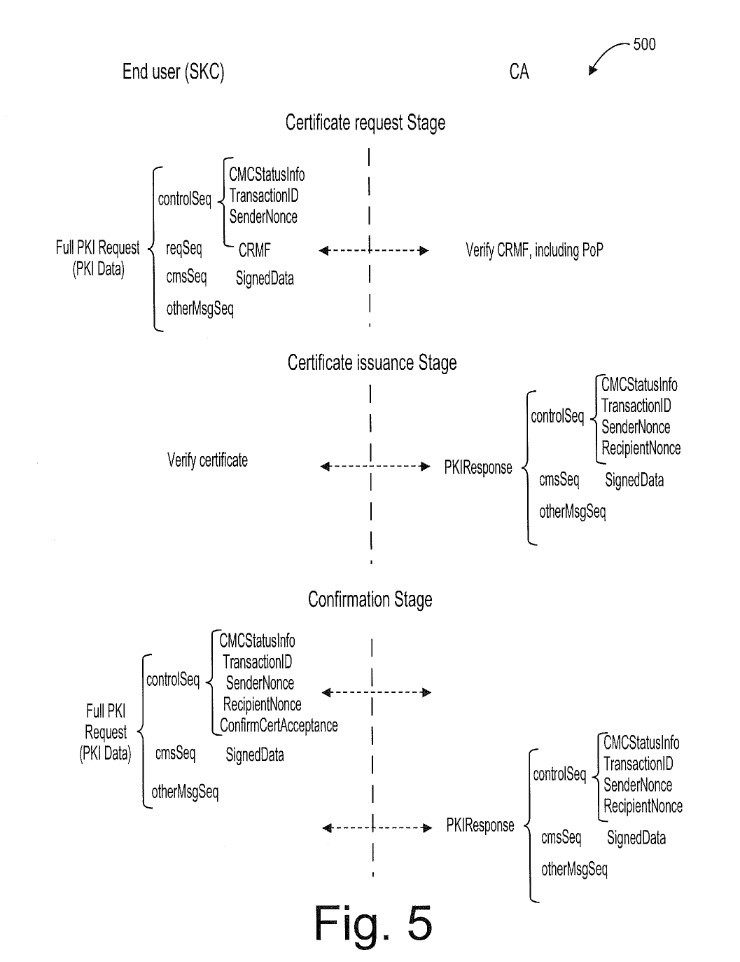

FIG. 5 depicts an example exchange 500 between an end user and a certification authority (CA). In particular, FIG. 5 shows the messages exchanged between the end user and the CA divided into the three stages: Certificate request, Certificate issuance and Confirmation. In the certification process, the cryptographic module creates a CRMF message, which includes the certificate request information and the Proof-of-Possession (PoP) of private key using in-bands mechanisms available for CRMF.

The CRMF ASN.1 structure is as follows:

```
CertReqMessages ::= SEQUENCE SIZE (1..MAX) OF CertReqMsg
CertReqMsg ::= SEQUENCE {
certReq CertRequest,
popo ProofOfPossession OPTIONAL,
        content depends upon key type
        regInfo SEQUENCE SIZE(1..MAX) of AttributeTypeAndValue
        OPTIONAL
}
```

Certain embodiments relate to a single new certificate request process. In these embodiments, CertReqMessages is a sequence of one CertReqMsg element. The regInfo field does not apply in these embodiments since the information relating to the context of the certificate request is provided in the certReq field, and no communication with a Registration Authority that could include additional information is supported.
The following describes the certificate request information (certReq field) and the information related to the Proof-of-Possession (popo field).
According to the CRMF format, CertRequest structure consists of fields:

```
CertRequest ::= SEQUENCE {
certReqId INTEGER, -- ID for matching request and reply
      certTemplate CertTemplate, --Selected fields of cert to be issued
      controls Controls OPTIONAL } -- Attributes affecting issuance
      where the controls field does not apply, certReqId is filled in by the
cryptographic module with the Body part Identifiers encoded, and
certTemplate is the structure which defines all the information that can be
included in the certificate request:
CertTemplate ::= SEQUENCE {
version [0] Version OPTIONAL,
serialNumber [1] INTEGER OPTIONAL,
signingAlg [2] AlgorithmIdentifier OPTIONAL,
issuer [3] Name OPTIONAL,
validity [4] OptionalValidity OPTIONAL,
subject [5] Name OPTIONAL,
publicKey [6] SubjectPublicKeyInfo OPTIONAL,
issuerUID [7] UniqueIdentifier OPTIONAL,
subjectUID [8] UniqueIdentifier OPTIONAL,
extensions [9] Extensions OPTIONAL }
OptionalValidity ::= SEQUENCE {
notBefore [0] Time OPTIONAL,
notAfter [1] Time OPTIONAL } --at least one must be present
Time ::= CHOICE {
utcTime UTCTime,
generalTime GeneralizedTime }
```

where version is filled in by the cryptographic module with value 2, serialnumber is assigned by the CA, signingAlg is assigned by the CA, issuer is assigned by the CA, validity may be assigned by the cryptographic module, in the following situations:

If the Certificate to be issued is going to be a one-time digital certificate, then the validity period must be less than 1 hour, with not Before equal to CurrentTime+1 minute and NotAfter equal to CurrentTime+1 hour.

If the Certificate to be issued is supposed to be cached by the application for further usage, then the application can provide a validity period. Otherwise, this field is left empty.

If the Certificate to be issued is going to be included in the HCD, then the end user is asked about the validity period for which they want to request the certificate.
subject is filled in by the cryptographic module with the subject Distinguished Name (DN) of the certificate stored in the HCD and extracted by the cryptographic module. publicKey is filled in by the cryptographic module with the public key included in the certificate stored in the HCD and extracted by the cryptographic module. In this implementation, issuerUID and subjectUID are omitted. extensions is filled in by the cryptographic module with new needed key usages/fields and with the Subject Key Identifier extension if necessary. This latter extension is necessary to sign the PKI Data if the end user does not have a digital certificate with signature purpose.

```
Extensions ::= SEQUENCE SIZE (1..MAX) OF Extension
Extension ::= SEQUENCE {
extnID OBJECT IDENTIFIER,
critical BOOLEAN DEFAULT FALSE,
extnValue OCTET STRING
        contains the DER encoding of an ASN.1 value
        corresponding to the extension type identified
        by extnID
}
```

The cryptographic module will add, as an extension in the CertTemplate structure, the keyUsage/field needed for the operation being carried out and if necessary the Subject Key Identifier extension (when the key pair does not have a digital certificate for signature purpose).

The KeyUsage data structure is:

```
id-ce-keyUsage OBJECT IDENTIFIER ::= { 2 5 29 15 }
KeyUsage ::= BIT STRING {
        digitalSignature (0),
        nonRepudiation (1), (in certain embodiments,
        may be renamed this bit to contentCommitment)
        keyEncipherment (2),
        dataEncipherment (3),
        keyAgreement (4),
        keyCertSign (5),
        cRLSign (6),
        encipherOnly (7),
        decipherOnly (8) }
```

Thus, Extension structure will have next values:

extnId equals to id-ce-keyUsage object identifier.

Critical marked as CRITICAL.

extnValue corresponds to the ASN.1 DER encoded structure of the KeyUsage structure above.

The KeyUsage value will be selected depending on the needs of Application 210 (see FIG. 2). The Subject Key Identifier extension provides a mechanism to identify certificates that contain a particular public key:

SubjectKeyIdentifier ::= KeyIdentifier
KeyIdentifier ::= OCTET STRING

With the exception of the PublicKey field, the CA is permitted to alter any requested field. The returned certificate needs to be checked by the requestor to see if the fields have been set in an acceptable manner. However, the CA typically uses the template fields if possible.

The Proof-of-Possession (PoP) depends on the purpose for which the certificate is being requested. Specified high-level purposes cover encryption, digital signature and/or key agreement. The request made by the end user might have more then one purpose. In the cases for which the public key is a multipurpose key, next priorities apply:

If requested public contains an encryption purpose, then the encryption method described below is used. The selected encryption method should be supported by the CA. Otherwise, and if requested public contains a digital signature purpose, then the end user follows the signature method described below. Finally, if neither of the above two purposes are requested, and the public key is for key agreement purposes, the key agreement method is used.

The following provides information regarding available methods of PoP. The data structure for PoP in such standard is as follows:

ProofOfPossession ::= CHOICE {
raVerified [0] NULL,
signature [1] POPOSigningKey,
keyEncipherment [2] POPOPrivKey,
keyAgreement [3] POPOPrivKey }

If requested public key is for encryption, the CA has three different methods: The private key can be provided to the CA, an encrypted challenge from the CA can be decrypted (direct method), or the created certificate can be returned encrypted and used as the challenge response (indirect method).
There is a restriction due to the CMC protocol on the use of the PoP method: Neither providing the private key nor the indirect method is supported by the protocol, therefore the direct method is used. The general structure ASN.1 for key encipherment keys is:

POPOPrivKey ::= CHOICE {
thisMessage [0] BIT STRING, -- deprecated
subsequentMessage [1] SubsequentMessage,
dhMAC [2] BIT STRING, -- deprecated
agreeMAC [3] PKMACValue,
encryptedKey [4] EnvelopedData }

for keyAgreement (only), possession is proven in this message (which contains a MAC (over the DER-encoded value of the certReq parameter in CertReqMsg, which must include both subject and publicKey) based on a key derived from the end entity's private DH key and the CA's public DH key);
the dhMAC value MUST be calculated as per the directions given in RFC 2875 for static DH proof-of-possession.

SubsequentMessage ::= INTEGER {
encrCert (0),
challengeResp (1) }

In particular implementations, the field subsequentMessage is challengeResp as the other methods are not supported.
Using the direct method, the value of the subsequentMessage is challengeResponse, which indicates that the CA sends a challenge to the end user and they need to decrypt it and generate a correct answer. Then, if the answer is correct, the CA will issue and send the new digital certificate to the end user.
If the public key to be certified includes signing purposes, the structure chosen in Proof-Of-Possession structure above must be the next:

```
POPOSigningKey ::= SEQUENCE {
poposkInput [0] POPOSigningKeyInput OPTIONAL,
algorithmIdentifier AlgorithmIdentifier,
signature BIT STRING }
POPOSigningKeyInput ::= SEQUENCE {
authInfo CHOICE {
        sender [0] GeneralName,
        used only if an authenticated identity has been
        established for the sender (e.g., a DN from a
        previously-issued and currently-valid certificate)
        publicKeyMAC PKMACValue },
        used if no authenticated GeneralName currently exists for
        the sender; publicKeyMAC contains a password-based MAC
        on the DER-encoded value of publicKey
        publicKey SubjectPublicKeyInfo } -- from CertTemplate
```

There are three cases that need to be looked at when doing a POP for a signature key. In one embodiment, the cryptographic module is associated with the third case, that is, “the certificate subject places its name in the Certificate Template structure along with the public key. In these cases the poposkInput is omitted from the POPOSigningKey structure. The signature field is computed over the DER-encoded certificate template structure.”

The public key used by the current CA to verify the Proof-of-Possession is already certified in a certificate issued by a CA belonging to another PKI (named, for example, PKI_1). Assume a trust relationship between the PKI_1 and the PKI to which the current CA belongs (PKI_2). Therefore, the registration/certification mechanism applies as if the user had a previous contact with the CA of PKI_2. Furthermore, the cryptographic module verifies the signature of the certificate issued by the CA (confirmation stage). Assume that the corresponding CA certificate is known and can be used by the cryptographic module.

If requested public key is for key agreement, both sides will establish a shared secret key. The methods to accomplish this task are the direct method, already explained above, and sharing a secret with the CA and use its value to generate a MAC information. The field of the POPPrivKey used for key agreement is agreeMAC which contains the MAC value computed by the shared secret.

Several entities participate during the process of requesting a new certificate, each of which performs a different task. Therefore, there are some issues that must be guaranteed not only to assure the identities of the users but also to make certain that all the policies defined in each entity are enforced. The main function of the Certification Practice Statement (CPS) is to state the practices and mechanism that a CA employs in all the tasks related to the issuance, management, revocation and renewal/re-keying of certificates. It also takes care of the relationship between all the entities which participate in a PKI, such as the subscriber, the CA, the RA, the relying party and any other participant or authority. Since the CPS may contain sensitive details of its system, only a summary or abstract of it is usually published.

One limitation of the CPS is that it does not constitute a contract nor bind PKI participants. Therefore, in most of the cases it is necessary to include a separate document that incorporates part of the CPS references to create a contractual relationship between the parties.

There is another concept important to define the policy and the relationships in a PKI. It is the Certificate Policy (CP). The CP is a set of rules, requirements and standards imposed by the PKI with respect to the various topics. In summary, the CP establishes what participants must do and applies to multiple CAs, organizations and domains. Additionally, CPS states how a CA and other participants behave in a certain domain, i.e. it is applied to a single CA, implementing all the procedures to meet the requirements of CP.

In certain situations, the CA receiving the request for the new keyUsage/field information is not the same or is not included in the same PKI as the CA that previously certificated the cryptographic key pair. In this case, the end user needs knowledge of the CPS of both PKIs to maintain the security level and to perform the necessary aspects their corresponding protocols need.

The CP should identify a set of applications or uses for certificates and establish the level of security for them. Then, it may present the appropriate PKI requirements for those applications/users. The PKI supports security services to provide Identification, Authentication and Integrity through the Proof-of-Possession processes, such as digital signatures and key exchanges. Levels of assurance define the behavior of the CAs respecting the certificate recipients' identification and the issuance, management and revocation of such certificates. A CPS states how a CA establishes the assurance. A CA can implement CP at several levels of assurance. The choice of the level of assurance will depend on the Proof-of-Possession process which is being used each time signature, encryption or key agreement is requested.

The certificate validity period of the new digital certificate will depend on the PKI levels of assurance chosen for the application and on the KeyUsage/field required. For example, the security and validity period for the digital signature should not be the same as for key encryption or key agreement. The challenge with the certificate validity period is the one-time digital certificate (OTDC) issue. When an OTDC is required, the validity period should not be the same as the one in a normal digital certificate. The problem lies in the fact that the OTDC has a limited period of use, due to its own definition: When the HCD is disconnected, the OTDC will be “lost” together with all the other data in the software cache. Therefore, the OTDC validity period does not need to be higher than the availability time, i.e. the time during which it is stored in the software cache. Otherwise the CA will issue and manage many digital certificates when only the last one or even none of them are necessary.

The cryptographic module will assign to the CRMF the same validity period as the period which the extracted digital certificate had. Additionally, if necessary (such as with the OTDC) the cryptographic module will allow assigning a different validity period to the new digital certificate.

Proving credentials of the user's identity is not an isolated process to be done in a single moment of the whole certificate management process. It is necessary to assure the user's identity during the whole process to all the entities of the PKI. There are several methods in which this identity is assured and verified:

If the end user has a private key that has been previously certified with a digital certificate by a CA belonging to a PKI (PKI_1), the validity of this digital certificate, when the new KeyUsage/field information is requested, is verified regardless of whether the new CA is the same or is included in another PKI (PKI_2). This verification provides a Proof-of-Identity of the user.

Proof-of-Possession is the method through which the user provides a guarantee of their identify. Depending on which keyUsage/field information is requested, the Proof-of-Possession method differs, but the result is that the end user proves their identity against the CA. In particular embodiments, the Proof-of-Identity is done using online methods.

The Hardware Cryptographic Device (HCD) 216 is the physical support on which the key pair is embedded and which contains the digital certificate with the different KeyUsages of the corresponding public key. An example HCD is a smart card, which is any card with embedded integrated circuits that can process data and logic programs. There are several categories of smart cards:

Memory cards, which contain only non-volatile memory storage components and sometimes some specific security logic.

Microprocessor cards, which contain microprocessor components in addition to memory components. The microprocessor allows the card to perform different functions and to use different applications.

Cryptographic cards are advanced microprocessor cards equipped with specialized cryptographic hardware which can perform cryptographic algorithms.

Most cryptographic cards are equipped with specialized cryptographic hardware that allows the use of algorithms such as RSA and Digital Signature Algorithm (DSA). These cards are also able to generate key pairs on the card, thereby avoiding the risk of having more than one copy of the key. The main use of the smart card is for digital signature and secure identification purposes.

Another embodiment is used to identify its owner unmistakably in an electronic scope. This identification is done by providing the digital Identity Card (Id-Card) itself with cryptographic tools and certificates which make possible to perform several cryptographic processes, such as digital signature.

A specific embodiment relates to the Spanish Id-Card, (e-DNI) which provides the following features:

Dealing with the public administration in order to carry out all its functions (eAdministration).

Making secure transactions between banks

Using a personal computer in a secure way by personal identification.

Carrying out any kind of application through the Internet with the certainty of the identity of the user, such as online purchases.

The e-DNI has an EEPROM with 34 Kbytes of capacity. The data in the chip is distributed in three different zones with different access permissions. It has a public zone, a private zone and a secure zone. The permissions of the user for each zone are different.

The invention may also involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Embodiments of the system and method described herein facilitate the use of cryptographic keys. Additionally, some embodiments may be used in conjunction with one or more conventional devices, such as computing devices. For example, one embodiment may be used as an improvement of existing computing devices and/or communication devices.

Although the components and modules illustrated herein are shown and described in a particular arrangement, the arrangement of components and modules may be altered to utilize cryptographic keys in a different manner. In other embodiments, one or more additional components or modules may be added to the described systems, and one or more components or modules may be removed from the described systems. Alternate embodiments may combine two or more of the described components or modules into a single component or module.

Although specific embodiments of the invention have been described and illustrated, the invention is not to be limited to the specific forms or arrangements of parts so described and illustrated. The scope of the invention is to be defined by the claims appended hereto and their equivalents.

1. A method comprising:
reading an existing digital certificate from a hardware cryptographic device, wherein the existing digital certificate includes an existing key pair;
extracting a public key from the existing digital certificate;
generating a certificate request message that identifies a new usage associated with the public key;
signing the certificate request message;
communicating the certificate request message to a certification authority;
receiving a new digital certificate from the certification authority, wherein the new digital certificate includes the new usage; and
applying the new digital certificate to a cryptographic operation using the existing key pair.

2. The method of claim 1, wherein the hardware cryptographic device is incapable of storing additional data.

3. The method of claim 1, wherein the hardware cryptographic device is a smart card.

4. The method of claim 1, wherein the cryptographic operation is a digital signing operation.

5. The method of claim 1, wherein the cryptographic operation is an encryption operation.

6. The method of claim 1, wherein the hardware cryptographic device is a Universal Serial Bus token.

7. The method of claim 1, wherein generating a certificate request message that identifies a new usage associated with the public key includes generating the certificate request message using a certificate request message format.

8. The method of claim 1, further comprising requesting a password from a user associated with the hardware cryptographic device prior to extracting the public key from the digital certificate.

9. The method of claim 1, further comprising requesting a personal identification number from a user associated with the hardware cryptographic device prior to extracting the public key from the digital certificate.

10. The method of claim 1, wherein the new public key usage is not supported by the existing digital certificate.

11. The method of claim 1, wherein the new public key usage is not included in the existing digital certificate.

12. The method of claim 1, further comprising storing the new digital certificate in the hardware cryptographic device.

13. The method of claim 1, further comprising deleting the new digital certificate upon completion of the cryptographic operation.

14. A method comprising:
reading an existing digital certificate from a hardware cryptographic device, wherein the existing digital certificate includes an existing key pair;
extracting a public key from the existing digital certificate;
generating a certificate request message that identifies a new field associated with the public key;
signing the certificate request message;
communicating the certificate request message to a certification authority;
receiving a new digital certificate from the certification authority, wherein the new digital certificate includes the new field; and
applying the new digital certificate to a cryptographic operation using the existing key pair.

15. The method of claim 14, wherein the hardware cryptographic device is incapable of storing additional data.

16. The method of claim 14, wherein the cryptographic operation is a digital signing operation.

17. The method of claim 14, wherein the cryptographic operation is an encryption operation.

18. The method of claim 14, further comprising requesting a password from a user associated with the hardware cryptographic device prior to extracting the public key from the digital certificate.

19. The method of claim 14, further comprising requesting a personal identification number from a user associated with the hardware cryptographic device prior to extracting the public key from the digital certificate.

20. The method of claim 14, wherein the new field is not supported by the existing digital certificate.

21. The method of claim 14, wherein the new field is not contained in the existing digital certificate.

22. The method of claim 14, further comprising deleting the new digital certificate upon completion of the cryptographic operation.

23. A method comprising:
generating a request for a new digital certificate identifying a new usage, wherein the new usage is unsupported by an existing digital certificate;
communicating the request to a certification authority;
receiving the new digital certificate from the certification authority, wherein the new digital certificate includes the new usage;
performing a cryptographic operation using the new digital certificate and the existing key pair during a current session; and
deleting the new digital certificate at the end of the current session.

24. The method of claim 23, wherein generating a request for a new digital certificate identifying a new usage includes reading the existing digital certificate from a hardware cryptographic device.

25. The method of claim 23, wherein generating a request for a new digital certificate identifying a new usage includes extracting a public key from the existing digital certificate.

26. The method of claim 23, further comprising storing the new digital certificate in a volatile memory device during the current session.

27. The method of claim 23, further comprising storing the new digital certificate in a hardware cryptographic device during the current session.

28. The method of claim 23, wherein the end of the current session occurs when a hardware cryptographic device storing the existing digital certificate is disconnected.

29. A method comprising:
generating a request for a new digital certificate identifying a new field associated with the digital certificate, wherein the new field is not included in an existing digital certificate;
communicating the request to a certification authority;
receiving the new digital certificate from the certification authority, wherein the new digital certificate includes the new field;
performing a cryptographic operation using the new digital certificate and the existing key pair during a current session; and
deleting the new digital certificate at the end of the current session.

30. The method of claim 29, wherein generating a request for a new digital certificate identifying a new field includes reading the existing digital certificate from a hardware cryptographic device.

31. The method of claim 29, wherein generating a request for a new digital certificate identifying a new field includes extracting a public key from the existing digital certificate.

32. The method of claim 29, further comprising storing the new digital certificate in a volatile memory device during the current session.

33. The method of claim 29, further comprising storing the new digital certificate in a hardware cryptographic device during the current session.

34. The method of claim 29, wherein the end of the current session occurs when a hardware cryptographic device storing the existing digital certificate is disconnected.

35. An apparatus comprising:
a cryptographic hardware driver configured to communicate with a hardware cryptographic device coupled to the apparatus; and
a cryptographic module coupled to the cryptographic hardware driver and configured to generate a request for a new digital certificate identifying a new usage or a new field that is unsupported by an existing digital certificate, the cryptographic module further to receive a new digital certificate including the new usage or field from a certification authority and to perform a cryptographic operation using the new digital certificate and a public key stored on the hardware cryptographic device, wherein the cryptographic module is further configured to delete the new digital certificate upon completion of the current session.

36. The apparatus of claim 35, wherein completion of the current session occurs when the hardware cryptographic device is decoupled from the apparatus.

37. The apparatus of claim 35, wherein the cryptographic module is configured to exchange data with the hardware cryptographic device via the cryptographic hardware driver.

38. The apparatus of claim 35, further comprising a communication module coupled to the cryptographic module and configured to communicate with the certification authority and a registration authority.

39. The apparatus of claim 35, further comprising a storage device coupled to the cryptographic module and configured to store the new digital certificate during the current session.
